(19) United States
(12) Patent Application Publication
(10) Pub. No.: US 2019/0316413 A1
(43) Pub. Date: Oct. 17, 2019

(54) WINDOW SHADE AND PANEL ASSEMBLY THEREOF

(71) Applicant: Teh Yor Co., Ltd., New Taipei City (TW)

(72) Inventor: Chien-Lan HUANG, New Taipei City (TW)

(21) Appl. No.: 16/371,944

(22) Filed: Apr. 1, 2019

Related U.S. Application Data
(60) Provisional application No. 62/656,953, filed on Apr. 12, 2018.

(51) Int. Cl. E06B 9/386; E06B 9/34; E06B 9/264

(52) U.S. Cl. CPC E06B 9/386; E06B 2009/2405; E06B 9/264; E06B 9/34

(57) ABSTRACT

A panel assembly for a window shade includes a first and a second panel, and a plurality of transversal parts disposed between the first and second panels, each of the transversal parts being respectively attached to the first and second panels and including at least one cell having a hollow cell interior, wherein the first and second panels are movable relative to each other in opposite directions to pivot the transversal parts. Moreover, the panel assembly may include a plurality of flaps respectively coupled to the transversal parts, the flap of each transversal part respectively overlapping a connection region where an adjacent transversal part is attached to one of the first and second panels in a closed state of the panel assembly.

### CROSS-REFERENCE TO RELATED APPLICATION(S)

This application claims priority to U.S. provisional patent application No. 62/656,953 filed on Apr. 12, 2018, the disclosure of which is incorporated herein by reference.

### BACKGROUND

### 1. Field of the Invention

The present invention relates to window shades, and panel assemblies for window shades.

### 2. Description of the Related Art

Many types of window shades are currently available on the market, such as roller shades, Venetian blinds and honeycomb shades. Conventionally, the window shade is provided with an operating cord that can be actuated to raise and lower the window shade. Certain types of window shades may include a panel assembly having multiple transversal vanes that may be adjusted to close or open the panel assembly. When the panel assembly is closed, the transversal vanes overlap one another so that light passage through the panel assembly may be blocked. Unfortunately, the aforementioned panel assembly usually has a structure that may not offer desirable thermal insulation. Moreover, light leakage may undesirably occur at the connections of the transversal vanes.

Therefore, there is a need for an improved window shade that can provide better thermal insulation and address at least the foregoing issues.

### SUMMARY

The present application describes a panel assembly for a window shade that can provide improved thermal insulation and prevent light leakage. According to an embodiment, the panel assembly includes a first and a second panel, and a plurality of transversal parts disposed between the first and second panels, each of the transversal parts being respectively attached to the first and second panels and including at least one cell having a hollow cell interior, wherein the first and second panels are movable relative to each other in opposite directions to pivot the transversal parts.

According to another embodiment, the panel assembly includes a first and a second panel, a first and a second transversal part disposed between the first and second panels, each of the first and second transversal parts being respectively attached to the first and second panels, the first and second panels being movable relative to each other in opposite directions to pivot the first and second transversal parts for switching the panel assembly between an open state and a closed state, and a first and a second flap respectively coupled to the first and second transversal parts, the first flap of the first transversal part overlapping a connection region where the second transversal part is attached to the first panel in the closed state.

Moreover, the present application provides a window shade that incorporates the panel assembly.

### BRIEF DESCRIPTION OF THE DRAWINGS

FIG. 1 is a perspective view illustrating an embodiment of a window shade in a fully raised or retracted state.

FIG. 2 is a perspective view illustrating the window shade of FIG. 1 in a lowered and closed state;

FIG. 3 is a perspective view illustrating the window shade of FIG. 1 in a lowered and open state;

FIG. 4 is an enlarged side view illustrating an embodiment of a panel assembly for a window shade in an open state;

FIG. 5 is an enlarged side view illustrating the panel assembly of FIG. 4 in a closed state;

FIG. 6 is an enlarged side view illustrating a variant construction of a panel assembly for a window shade in an open state;

FIG. 7 is an enlarged side view illustrating the panel assembly of FIG. 6 in a closed state;

FIG. 8 is an enlarged side view illustrating another variant construction of a panel assembly for a window shade in an open state;

FIG. 9 is an enlarged side view illustrating the panel assembly of FIG. 8 in a closed state;

FIG. 10 is an enlarged side view illustrating another embodiment of a panel assembly for a window shade in an open state;

FIG. 11 is an enlarged side view illustrating the panel assembly of FIG. 10 in a closed state;

FIG. 12 is an enlarged side view illustrating another embodiment of a panel assembly for a window shade in an open state;

FIG. 13 is an enlarged side view illustrating the panel assembly of FIG. 12 in a closed state;

FIG. 14 is an enlarged side view illustrating another embodiment of a panel assembly for a window shade in an open state;

FIG. 15 is enlarged side view illustrating the panel assembly of FIG. 14 in a closed state;

FIG. 16 is an enlarged side view illustrating another embodiment of a panel assembly for a window shade in an open state;

FIG. 17 is an enlarged side view illustrating the panel assembly of FIG. 16 in a closed state;

FIG. 18 is an enlarged side view illustrating another embodiment of a panel assembly for a window shade in an open state;

FIG. 19 is an enlarged side view illustrating the panel assembly of FIG. 18 in a closed state;

FIG. 20 is an enlarged side view illustrating another embodiment of a panel assembly for a window shade in an open state;

FIG. 21 is an enlarged side view illustrating the panel assembly of FIG. 20 in a closed state;

FIG. 22 is an enlarged side view illustrating another embodiment of a panel assembly for a window shade in an open state;

FIG. 23 is an enlarged side view illustrating the panel assembly of FIG. 22 in a closed state;

FIG. 24 is an enlarged side view illustrating another variant construction of a panel assembly for a window shade in an open state;

FIG. 25 is an enlarged side view illustrating the panel assembly of FIG. 24 in a closed state;

FIG. 26 is an enlarged side view illustrating another variant construction of a panel assembly for a window shade in an open state; and

FIG. 27 is an enlarged side view illustrating the panel assembly of FIG. 26 in a closed state.

### DETAILED DESCRIPTION OF THE EMBODIMENTS

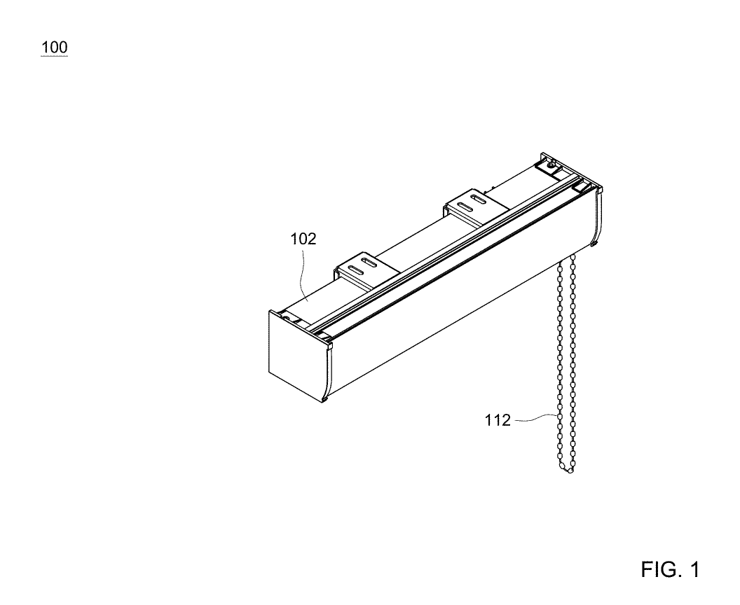

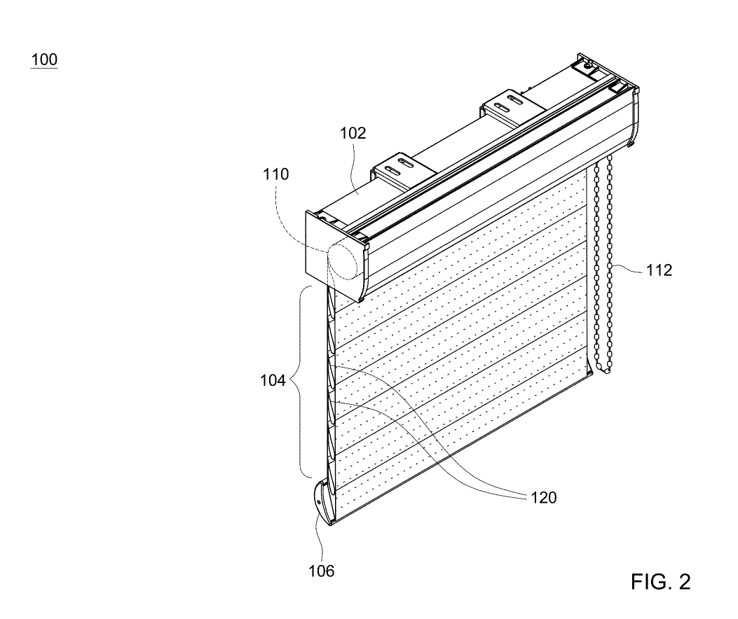

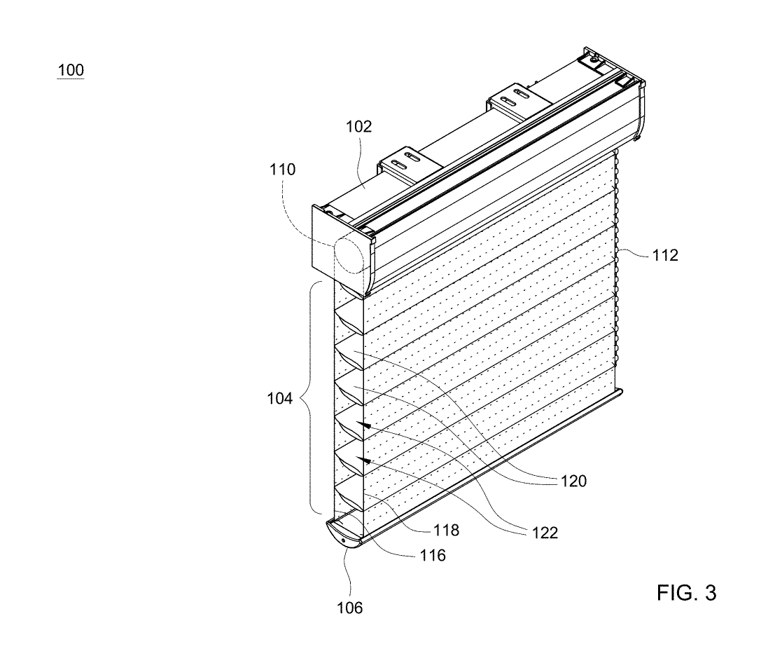

FIGS. 1-3 are perspective views respectively illustrating an embodiment of a window shade 100 in a fully raised or retracted state, a lowered and closed state, and a lowered and open state. Referring to FIGS. 1-3, the window shade 100 can include a head frame 102, a panel assembly 104, a bottom part 106, and an actuating system assembled with the head frame 102 for controlling the movement of the panel assembly 104. For example, the actuating system may include a roller 110 (shown with phantom lines in FIGS. 2 and 3) and at least one operating member 112, the roller 110 being pivotally connected with the head frame 102 and rotatable to wind and unwind the panel assembly 104, and the operating member 112 being operable to drive the roller 110 in rotation in either direction.

The head frame 102 may be affixed at a top of a window frame, and may have any desirable shapes. Moreover, the head frame 102 can have an inner cavity for at least partially receiving the actuating system of the window shade 100 (e.g., the roller 110).

The panel assembly 104 can have an upper and a lower end respectively connected with the roller 110 and the bottom part 106. The panel assembly 104 can include two panels 116 and 118, and a plurality of parallel transversal parts 120. Each of the two panels 116 and 118 can have a width extending generally horizontally, and a length perpendicular to the width. The transversal parts 120 are disposed between the two panels 116 and 118, are respectively attached to the two panels 116 and 118 and are distributed along the length of the two panels 116 and 118. According to an example of construction, the two panels 116 and 118 may be made of flexible materials including, but not limited to, fabrics, web materials, mesh materials, and the like. Examples of suitable materials for the transversal parts 120 may include, without limitation, fabric materials, web materials, mesh materials, plastic films, and the like. In some implementations, the two panels 116 and 118 may be exemplary transparent or translucent, and the transversal parts 120 may be opaque or have a light transmissivity smaller than the light transmissivity of the two panels 116 and 118. The panel assembly 104 can be retracted toward an interior of the head frame 102 and wound around the roller 110, and expanded below the head frame 102.

When the panel assembly 104 is expanded or lowered outside the head frame 102, the panel assembly 104 is further switchable between a closed state and an open state by moving the two panels 116 and 118 relative to each other in vertically opposite directions, which pivots the transversal parts 120 between different angular positions. For example, the panel assembly 104 may be switched between the closed state and the open state by controllably rotating the roller 110. In other embodiments, the panel assembly 104 may be switched between the closed state and the open state by a mechanism provided in the head frame 102 that is operable to impart a relative sliding between the two panels 116 and 118. When the panel assembly 104 is in the closed state, the transversal parts 120 are positioned generally vertically and adjacently overlap with one another as shown in FIG. 2, which can block or reduce light passage. When the panel assembly 104 is in the open state, the transversal parts 120 can be positioned generally horizontally parallel so that the transversal parts 120 are spaced apart from one another by a plurality of gaps 122 as shown in FIG. 3, which can facilitate light passage through the panel assembly 104.

Referring to FIGS. 2 and 3, the bottom part 106 is disposed at a bottom of the panel assembly 104 as a weighing structure, and is movable vertically along with the panel assembly 104 as the panel assembly 104 is retracted toward or expanded from the head frame 102.

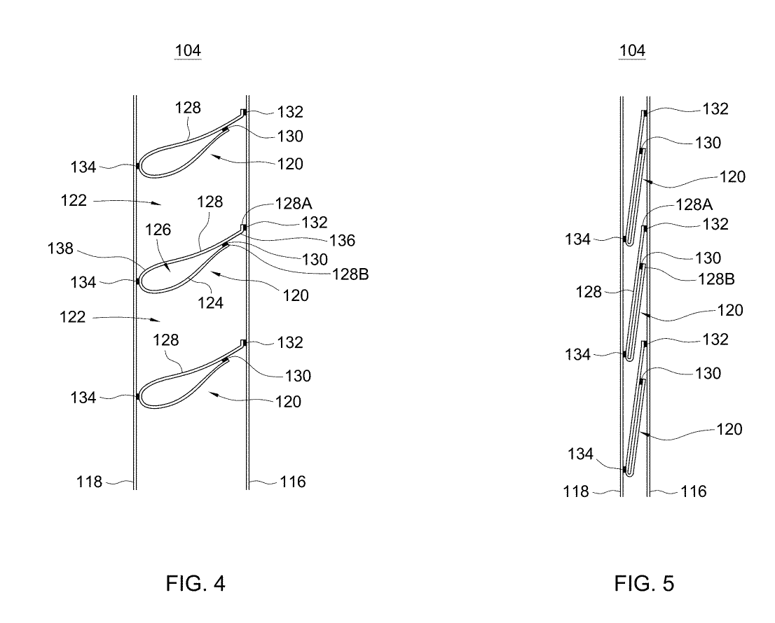

In conjunction with FIGS. 1-3, FIGS. 4 and 5 are two enlarged side views illustrating an embodiment of the panel assembly 104. Referring to FIGS. 4 and 5, each of the transversal parts 120 in the panel assembly 104 can respectively include at least one cell 124 having a hollow cell interior 126 that is respectively attached to the two panels 116 and 118. Each of the transversal parts 120 can extend along the width direction of the panels 116 and 118.

According to an example of construction, each transversal part 120 can respectively include a strip 128 that is attached to the two panels 116 and 118 and is folded over to delimit at least partially the hollow cell interior 126 of the cell 124. The strip 128 may be a single strip of a flexible material. Examples of suitable materials for the strip 128 may include, without limitation, fabric materials, web materials, mesh materials, plastic films, and the like. The strip 128 can have two opposite ends 128A and 128B, and can be folded over so that the end 128B can be attached to a region of the strip 128 located between the two ends 128A and 128B. For example, the end 128B of the strip 128 may be attached to a region of the strip 128 between the two ends 128A and 128B with an adhesive layer 130. The cell 124 may be respectively attached to the two panels 116 and 118 with two adhesive layers 132 and 134. For example, the strip 128 may have two opposite surfaces 136 and 138, a portion of the surface 136 facing inward the hollow cell interior 126, and the surface 138 facing outward the cell 124. The adhesive layer 132 can be applied to attach the panel 116 to the surface 136 at the end 128A of the strip 128, and the adhesive layer 134 can be applied to attach the panel 118 to the surface 138 of the strip 128.

Referring to FIGS. 1-5, the window shade 100 may be installed on a window frame of a room with the panel 118 of the panel assembly 104 facing the interior of the room. When the panel assembly 104 is in the open state as shown in FIG. 4, the respective cells 124 of the transversal parts 120 may be expanded and spaced apart from one another by the gaps 122 for light passage. When the panel assembly 104 is in the closed state as shown in FIG. 5, the respective cells 124 of the transversal parts 120 may be collapsed and adjacently overlap with one another for blocking or reducing light passage. The cellular structure of the transversal parts 120 may provide improved thermal insulation and better block or reduce light passage when the panel assembly 104 is in the closed state.

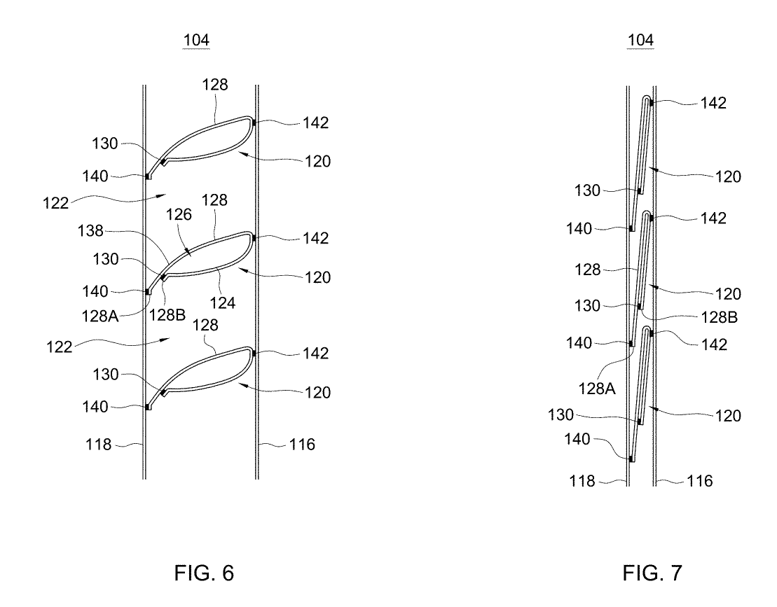

FIGS. 6 and 7 are two enlarged side views illustrating a variant construction of the panel assembly 104. Like previously described, the panel assembly 104 shown in FIGS. 6 and 7 can include a plurality of transversal parts 120 with each transversal part 120 formed by a strip 128 folded over to define a cell 124. The panel assembly 104 of FIGS. 6 and 7 differs in the attachment of each transversal part 120 to the two panels 116 and 118. Referring to FIGS. 6 and 7, the same surface 138 of the strip 128 can be respectively attached to the two panels 116 and 118 at two distant locations. For example, an adhesive layer 140 can be applied to attach the panel 118 to the surface 138 at the end 128A of the strip 128, and another adhesive layer 142 can be applied to attach the panel 116 to the surface 138 of the strip 128 at a distant location from the adhesive layer 140. When the window shade is installed on a window frame of a room, the panel 118 of the panel assembly 104 can face the interior of the room.

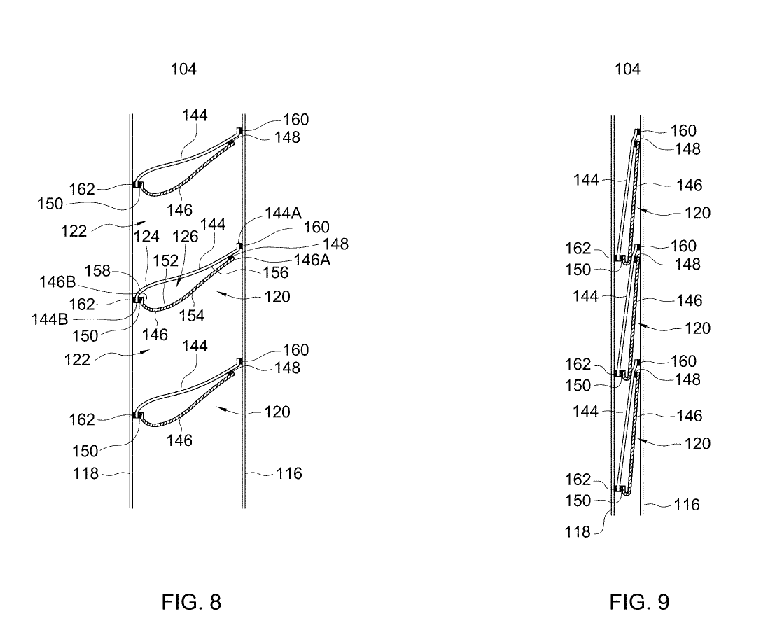

FIGS. 8 and 9 are two enlarged side views illustrating another variant construction of the panel assembly 104. Like previously described, the panel assembly 104 shown in FIGS. 8 and 9 includes a plurality of transversal parts 120 with each transversal part 120 forming a cell 124 respectively attached to the two panels 116 and 118. The panel assembly 104 of FIGS. 8 and 9 differs in the assembly and attachment of each transversal part 120 to the two panels 116 and 118. More specifically, each transversal part 120 can have a same structure including two strips 144 and 146 that are attached to each other to delimit at least partially the hollow cell interior 126 of the cell 124. The two strips 144 and 146 may be made of a same material or different materials. Examples of suitable materials for the strips 144 and 146 may include, without limitation, fabric materials, web materials, mesh materials, plastic films, and the like. Moreover, the two strips 144 and 146 may have different light transmissivities. For example, the strip 144 may be semi-transparent, and the strip 146 may be opaque and block light passage.

The strip 146 may have two opposite ends 146A and 146B respectively attached to the strip 144 through two adhesive layers 148 and 150. For example, the strip 146 may have two opposite surfaces 152 and 154 extending between the two opposite ends 146A and 146B, the adhesive layer 148 may be applied to attach the surface 152 at the end 146A of the strip 146 to a surface 156 of the strip 144, and the adhesive layer 150 may be applied to attach the surface 154 at the end 146B of the strip 146 to the surface 156 of the strip 144. The end 146B of the strip 146 may be attached to the strip 144 adjacent to an end 144B of the strip 144, and the end 146A of the strip 146 may be attached to the strip 144 closer to another end 144A of the strip 144 opposite to the end 144B. The two strips 144 and 146 can thereby define the hollow cell interior 126.

Referring to FIGS. 8 and 9, each transversal part 120 may be respectively attached to the two panels 116 and 118 with two adhesive layers 160 and 162. For example, the strip 144 may have two opposite surfaces 156 and 158 extending between the two opposite ends 144A and 144B, the adhesive layer 160 may be applied to attach the panel 116 to the surface 156 at the end 144A of the strip 144, and the adhesive layer 162 may be applied to attach the panel 118 to the surface 158 at the end 144B of the strip 144.

Referring to FIGS. 8 and 9, the window shade may be installed on a window frame of a room with the panel 118 of the panel assembly 104 facing the interior of the room. When the panel assembly 104 is in the open state as shown in FIG. 8, the cells 124 may be expanded and spaced apart from one another by the gaps 122 for light passage. When the panel assembly 104 is in the closed state as shown in FIG. 9, the cells 124 may be collapsed and adjacently overlap with one another for blocking or reducing light passage.

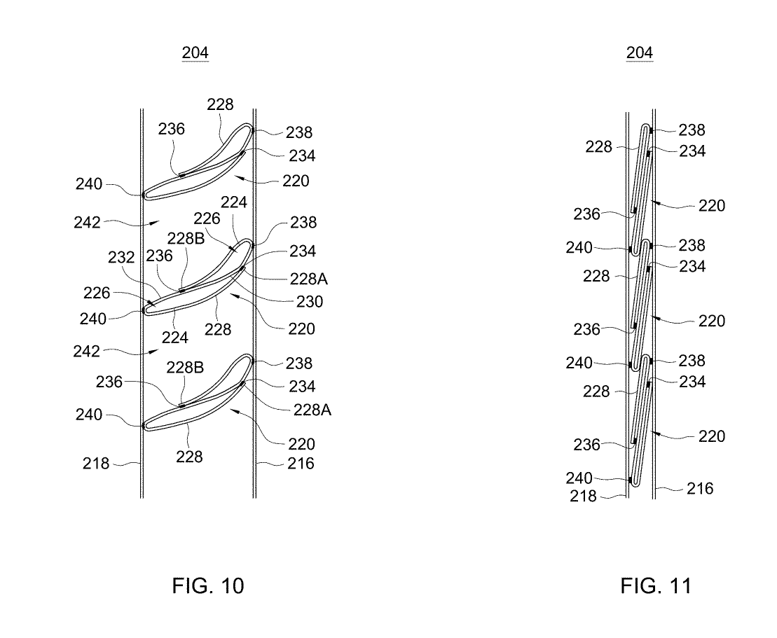

FIGS. 10 and 11 are two enlarged side views illustrating another embodiment of a panel assembly 204 that may substitute for the aforementioned panel assemblies 104 in the window shade 100 shown in FIGS. 1-3. Referring to FIGS. 10 and 11, the panel assembly 204 can include two panels 216 and 218, and a plurality of parallel transversal parts 220 disposed between and respectively attached to the two panels 216 and 218. The two panels 216 and 218 may be made of flexible materials including, but not limited to, fabric materials, web materials, mesh materials, and the like. Examples of suitable materials for the transversal parts 220 may include, without limitation, fabric materials, web materials, mesh materials, plastic films, and the like. In some implementations, the two panels 216 and 218 may be exemplary transparent or translucent, and the transversal parts 220 may be opaque or have a light transmissivity smaller than the light transmissivity of the two panels 216 and 218. Each of the transversal parts 220 can respectively include a plurality of cells 224 with each cell 224 having a distinct hollow cell interior 226, and can extend along the width direction of the panels 216 and 218 (i.e., perpendicular to the plane of FIGS. 10 and 11).

According to an example of construction, each transversal part 220 can respectively include a strip 228 that is attached to the two panels 216 and 218 and is folded over to delimit the cells 224. The strip 228 may be a single strip of a flexible material. Examples of suitable materials for the strip 228 may include, without limitation, fabric materials, web materials, mesh materials, plastic films, and the like. The strip 228 can have two opposite ends 228A and 228B, and two opposite surfaces 230 and 232 extending between the two ends 228A and 228B. The strip 228 can be folded over multiple times as shown in FIG. 10 so that the end 228A is attached to the surface 230 with an adhesive layer 234 and the end 228B is attached to the opposite surface 232 with an adhesive layer 236. Each transversal part 220 can thereby have two cells 224, and can be respectively attached to the two panels 216 and 218 with two adhesive layers 238 and 240.

The panel assembly 204 can operate like the panel assemblies 104 described previously: the two panels 216 and 218 can move relative to each other in opposite directions to pivot the transversal parts 220 between different angular positions. FIG. 10 illustrates the panel assembly 204 in an open state where the transversal parts 220 are positioned generally horizontally and are spaced apart from one another by a plurality of gaps 242 for facilitating light passage through the panel assembly 204. FIG. 11 illustrates the panel assembly 204 in a closed state where the transversal parts 220 are positioned generally vertically and adjacently overlap with one another for blocking or reducing light passage.

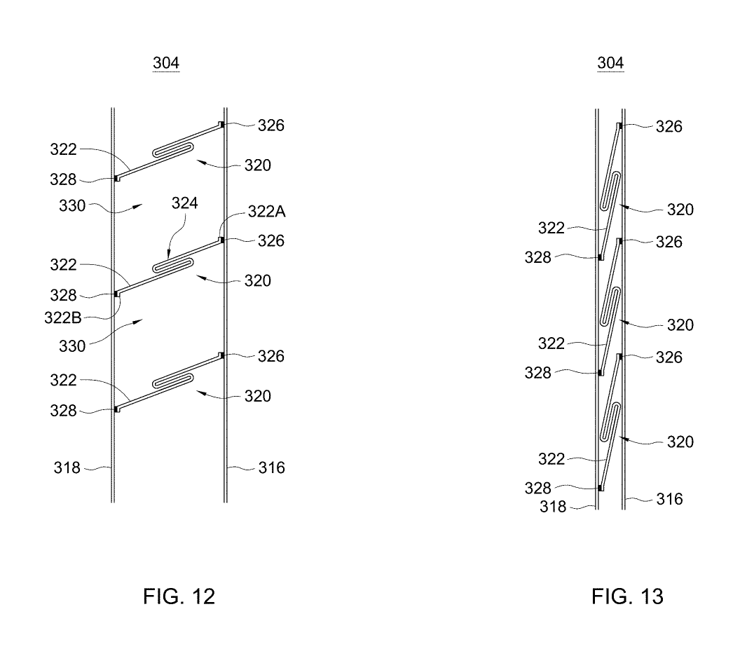

FIGS. 12 and 13 are two enlarged side views illustrating another embodiment of a panel assembly 304 for a window shade. Referring to FIGS. 12 and 13, the panel assembly 304 can include two panels 316 and 318, and a plurality of parallel transversal parts 320 disposed between and respectively attached to the two panels 316 and 318. The two panels 316 and 318 may be made of flexible materials including, but not limited to, fabric materials, web materials, mesh materials, and the like. Examples of suitable materials for the transversal parts 320 may include, without limitation, fabric materials, web materials, mesh materials, plastic films, and the like. In some implementations, the two panels 316 and 318 may be exemplary transparent or translucent, and the transversal parts 320 may be opaque or have a light transmissivity smaller than the light transmissivity of the two panels 316 and 318.

Each of the transversal parts 320 can extend along the width direction of the panels 316 and 318 (i.e., perpendicular to the plane of FIGS. 12 and 13), and can respectively include a strip 322 having two opposite ends 322A and 322B. Examples of suitable materials for the strip 322 may include, without limitation, fabric materials, web materials, mesh materials, plastic films, and the like. The strip 322 can be folded over multiple times to form a folded portion 324 between the two ends 322A and 322B. The folded portion 324 may provide certain mechanic properties to the transversal part 320. For example, because the transversal part 320 is thicker at the folded portion 324 than at the two ends 322A and 322B, some rigidity may be added to the transversal part 320. The two ends 322A and 322B of the strip 322 can be respectively attached to the two panels 316 and 318 with two adhesive layers 326 and 328.

The panel assembly 304 can operate like described previously: the two panels 316 and 318 can move relative to each other in opposite directions to pivot the transversal parts 320 between different angular positions. FIG. 12 illustrates the panel assembly 304 in an open state where the transversal parts 320 are positioned generally horizontally and are spaced apart from one another by a plurality of gaps 330 for facilitating light passage through the panel assembly 304. FIG. 13 illustrates the panel assembly 304 in a closed state where the transversal parts 320 are positioned generally vertically and adjacently overlap with one another for blocking or reducing light passage.

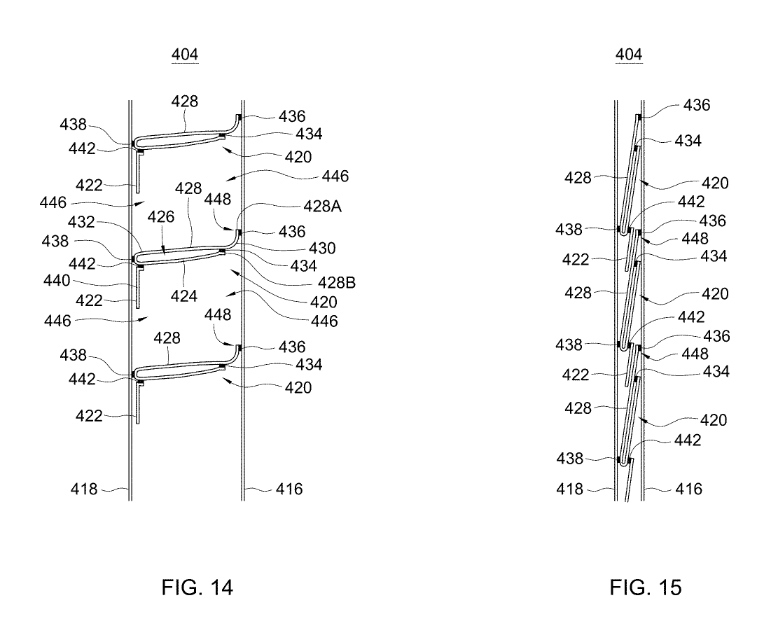

FIGS. 14 and 15 are two enlarged side views illustrating another embodiment of a panel assembly 404 for a window shade. Referring to FIGS. 14 and 15, the panel assembly 404 can include two panels 416 and 418, a plurality of parallel transversal parts 420 and a plurality of flaps 422. The transversal parts 420 are disposed between the two panels 416 and 418, each of the transversal parts 420 being respectively attached to the two panels 416 and 418. The two panels 416 and 418 may be made of flexible materials including, but not limited to, fabric materials, web materials, mesh materials, and the like. Examples of suitable materials for the transversal parts 420 may include, without limitation, fabric materials, web materials, mesh materials, plastic films, and the like. In some implementations, the two panels 416 and 418 may be exemplary transparent or translucent, and the transversal parts 420 may be opaque or have a light transmissivity smaller than the light transmissivity of the two panels 416 and 418.

According to an embodiment, each of the transversal parts 420 can extend along the width direction of the panels 416 and 418 (i.e., perpendicular to the plane of FIGS. 14 and 15), and can respectively include at least one cell 424 having a hollow cell interior 426 that is attached to the two panels 416 and 418. For example, each transversal part 420 can respectively include a strip 428 that is folded over to delimit at least partially the hollow cell interior 426 of the cell 424 and is respectively attached to the two panels 416 and 418. The strip 428 may be a single strip of a flexible material. Examples of suitable materials for the strip 428 may include, without limitation, fabric materials, web materials, mesh materials, plastic films, and the like. The strip 428 can have two opposite ends 428A and 428B, and two opposite surfaces 430 and 432 extending between the two ends 428A and 428B. The strip 428 can be folded over so that the end 428B is attached to a region of the strip 428 located between the two ends 428A and 428B. For example, the end 428B of the strip 428 may be attached to the surface 430 of the strip 428 in a region between the two ends 428A and 428B with an adhesive layer 434. Once the strip 428 is folded to form the cell 424, a portion of the surface 430 faces inward the hollow cell interior 426, and the surface 432 faces outward the cell 424. The cell 424 may be respectively attached to the two panels 416 and 418 with two adhesive layers 436 and 438. The adhesive layer 436 can be applied to attach the panel 416 to the surface 430 at the end 428A of the strip 428, and the adhesive layer 438 can be applied to attach the panel 418 to the surface 432 of the strip 428.

Referring to FIGS. 14 and 15, the flaps 422 are respectively coupled to the transversal parts 420, each flap 422 extending outside the hollow cell interior 426 of the transversal part 420 coupled thereto. All the flaps 422 may have a same structure and may be respectively coupled to the transversal parts 420 in a similar way. According to an example of construction, each flap 422 may be formed by a strip 440 having an end attached to the strip 428 of the transversal part 420 with an adhesive layer 442, and may protrude at a lower side of the transversal part 420 coupled thereto. Examples of suitable materials for the strip 440 may include, without limitation, fabric materials, web materials, plastic films, and the like. The flaps 422 and the transversal parts 420 may be made of a same material or include different materials. The strip 440 may be exemplary attached to the transversal part 420 adjacent to the location where the transversal part 420 attaches to the panel 418 so that the flap 422 is adjacent to the connection between the transversal part 420 and the panel 418. Each flap 422 may extend continuously or discontinuously along the transversal part 420 coupled thereto.

Referring to FIGS. 14 and 15, the window shade may be installed on a window frame of a room with the panel 418 of the panel assembly 404 facing the interior of the room. Like previously described, the two panels 416 and 418 can move relative to each other in opposite directions to pivot the transversal parts 420 between different angular positions. FIG. 14 illustrates the panel assembly 404 in an open state where the transversal parts 420 are positioned generally horizontally and are spaced apart from one another by a plurality of gaps 446 for facilitating light passage through the panel assembly 404. FIG. 15 illustrates the panel assembly 404 in a closed state where the transversal parts 420 are positioned generally vertically and adjacently overlap with one another for blocking or reducing light passage.

The flaps 422 are movable along with the transversal parts 420, and may be provided for reducing or blocking light passage. For example, each flap 422 may include an opaque material that can reduce or block light. When the panel assembly 404 is in the closed state, the flap 422 of each transversal part 420 can overlap a connection region 448 where one adjacent lower transversal part 420 is attached to the panel 416, as shown in FIG. 15. This may prevent undesirable light leakage at the connection between each transversal part 420 and the panel 416. When the panel assembly 404 is in the open state as shown in FIG. 14, the flaps 422 can be respectively displaced away from the connection regions 448.

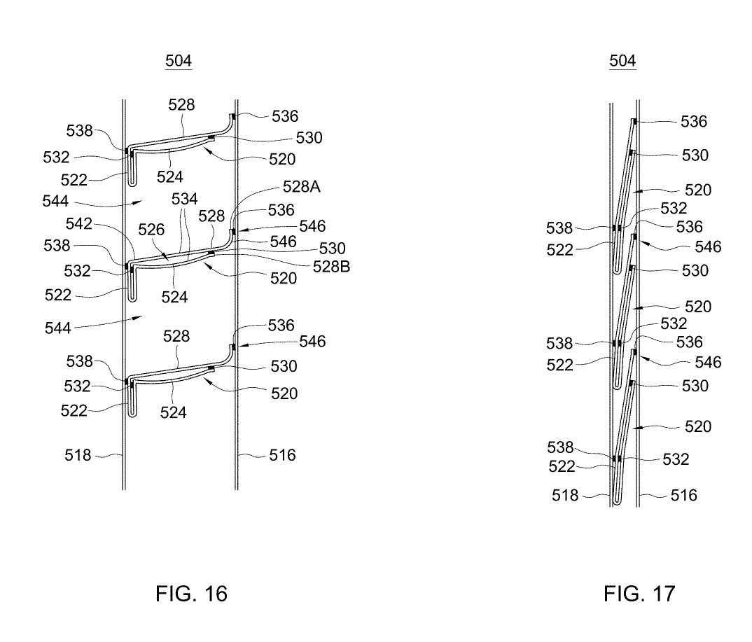

FIGS. 16 and 17 are two enlarged side views illustrating another embodiment of a panel assembly 504 for a window shade. Referring to FIGS. 16 and 17, the panel assembly 504 can include two panels 516 and 518, a plurality of parallel transversal parts 520, and a plurality of flaps 522 respectively coupled to the transversal parts 520. The transversal parts 520 are disposed between the two panels 516 and 518, each of the transversal parts 520 being respectively attached to the two panels 516 and 518. The two panels 516 and 518 may be made of flexible materials including, but not limited to, fabric materials, web materials, mesh materials, and the like. Examples of suitable materials for the transversal parts 520 may include, without limitation, fabric materials, web materials, mesh materials, plastic films, and the like. In some implementations, the two panels 516 and 518 may be exemplary transparent or translucent, and the transversal parts 520 may be opaque or have a light transmissivity smaller than the light transmissivity of the two panels 516 and 518.

Referring to FIGS. 16 and 17, each of the transversal parts 520 can extend along the width direction of the panels 516 and 518 (i.e., perpendicular to the plane of FIGS. 16 and 17), and can respectively include at least one cell 524 having a hollow cell interior 526 that is attached to the two panels 516 and 518. For example, each transversal part 520 can respectively include a strip 528 that is attached to the two panels 516 and 518 and is folded over to delimit at least partially the hollow cell interior 526 of the cell 524. The strip 528 may be a single strip of a flexible material. Examples of suitable materials for the strip 528 may include, without limitation, fabric materials, web materials, mesh materials, plastic films, and the like. The strip 528 can have two opposite ends 528A and 528B, and can be folded over so that the end 528B is attached to a region of the strip 528 located between the two ends 528A and 528B. For example, the end 528B of the strip 528 may be attached to a region of the strip 528 between the two ends 528A and 528B with an adhesive layer 530. Moreover, the folded strip 528 may be attached to itself with an adhesive layer 532 at another location so that the adhesive layer 530 is located between the adhesive layer 532 and the end 528A along the strip 528. The hollow cell interior 526 can be thereby defined between two portions 534 of the strip 528 that are attached to each other with the two adhesive layers 530 and 532.

Each transversal part 520 can be respectively attached to the two panels 516 and 518 with two adhesive layers 536 and 538. For example, the adhesive layer 536 can be applied to attach the panel 516 to a surface 540 of the strip 528 at the end 528A thereof, and the adhesive layer 538 can be applied to attach the panel 518 to another surface 542 of the strip 528 opposite to the surface 540. The adhesive layer 538 attaching the strip 528 to the panel 518 may be disposed close to the location where the adhesive layer 532 attaches the two portions 534 of the strip 528 together.

Referring to FIGS. 16 and 17, the flap 522 of each transversal part 520 can be formed integrally with the strip 528. More specifically, the flap 522 of each transversal part 520 can be formed by a folded tail portion of the strip 528 extending beyond the location where the adhesive layer 538 attaches the strip 528 to the panel 518 and beyond the location where the adhesive layer 532 attaches the two portions 534 of the strip 528 to each other. The flap 522 thereby formed can extend outside the hollow cell interior 526 of the corresponding transversal part 520 and protrude at a lower side thereof. Each flap 522 may extend continuously or discontinuously along the transversal part 520 coupled thereto.

Referring to FIGS. 16 and 17, the window shade may be installed on a window frame of a room with the panel 518 of the panel assembly 504 facing the interior of the room. Like previously described, the two panels 516 and 518 can move relative to each other in opposite directions to pivot the transversal parts 520 between different angular positions, and the flaps 522 are movable along with the transversal parts 520. FIG. 16 illustrates the panel assembly 504 in an open state where the transversal parts 520 are positioned generally horizontally and are spaced apart from one another by a plurality of gaps 544 for facilitating light passage through the panel assembly 504. FIG. 17 illustrates the panel assembly 504 in a closed state where the transversal parts 520 are positioned generally vertically and adjacently overlap with one another for blocking or reducing light passage. As shown in FIG. 17, when the panel assembly 504 is in the closed state, the flap 522 of each transversal part 520 can overlap a connection region 546 where one adjacent lower transversal part 520 is attached to the panel 516 with the adhesive layer 536. This may prevent undesirable light leakage at the connection between each transversal part 520 and the panel 516. When the panel assembly 504 is in the open state shown in FIG. 16, the flaps 522 can be respectively displaced away from the connection regions 546.

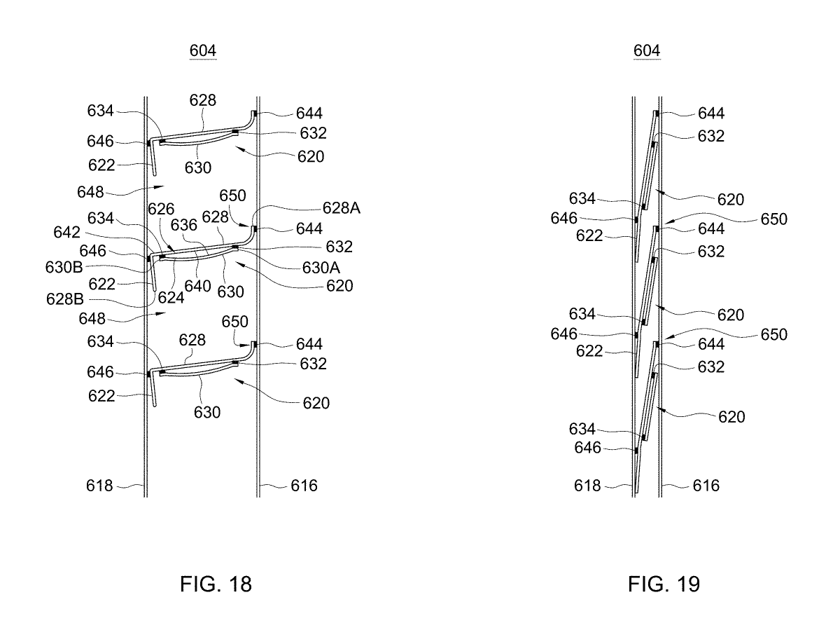

FIGS. 18 and 19 are two enlarged side views illustrating another embodiment of a panel assembly 604 for a window shade. Referring to FIGS. 18 and 19, the panel assembly 604 can include two panels 616 and 618, a plurality of parallel transversal parts 620, and a plurality of flaps 622 respectively coupled to the transversal parts 620. The transversal parts 620 are disposed between the two panels 616 and 618, each of the transversal parts 620 being respectively attached to the two panels 616 and 618. The two panels 616 and 618 may be made of flexible materials including, but not limited to, fabric materials, web materials, mesh materials, and the like. Examples of suitable materials for the transversal parts 620 may include, without limitation, fabric materials, web materials, mesh materials, plastic films, and the like. In some implementations, the two panels 616 and 618 may be exemplary transparent or translucent, and the transversal parts 620 may be opaque or have a light transmissivity smaller than the light transmissivity of the two panels 616 and 618.

Referring to FIGS. 18 and 19, each of the transversal parts 620 can extend along the width direction of the panels 616 and 618 (i.e., perpendicular to the plane of FIGS. 18 and 19), and can respectively include at least one cell 624 having a hollow cell interior 626 that is attached to the two panels 616 and 618. For example, each transversal part 620 can include two strips 628 and 630 that are attached to each other to delimit at least partially the hollow cell interior 626 of the cell 624. The two strips 628 and 630 may be made of a same material, or different materials. Examples of suitable materials for the strips 628 and 630 may include, without limitation, fabric materials, web materials, mesh materials, plastic films, and the like.

The strip 630 may have two opposite ends 630A and 630B respectively attached to the strip 628 with two adhesive layers 632 and 634. For example, the strip 630 may have a surface 636 extending between the two opposite ends 630A and 630B, the adhesive layer 632 may be applied to attach the surface 636 at the end 630A of the strip 630 to a surface 640 of the strip 628, and the adhesive layer 634 may be applied to attach the surface 636 at the end 630B of the strip 630 to the surface 640 of the strip 628. The two strips 628 and 630 can thereby define the hollow cell interior 626.

Referring to FIGS. 18 and 19, each transversal part 620 may be respectively attached to the two panels 616 and 618 with two adhesive layers 644 and 646. According to an embodiment, the two adhesive layers 644 and 646 may exemplary attach the two panels 616 and 618 to the strip 628 of each transversal part 620. For example, the strip 628 may have two opposite surfaces 640 and 642 extending between the two opposite ends 628A and 628B, the adhesive layer 644 may be applied to attach the panel 616 to the surface 640 at the end 628A of the strip 628, and the adhesive layer 646 may be applied to attach the panel 618 to the surface 642 of the strip 628 at a location distant from the adhesive layer 644.

The flap 622 of each transversal part 620 can be formed integrally with the strip 628. More specifically, the flap 622 of each transversal part 620 can be formed by a tail portion of the strip 628 that extends beyond the location where the adhesive layer 646 attaches the strip 628 to the panel 618 and terminates at the end 628B of the strip 628. The flap 622 thereby formed extends outside the hollow cell interior 626 of the corresponding transversal part 620 and protrudes at a lower side thereof. Each flap 622 may extend continuously or discontinuously along the transversal part 620 coupled thereto.

Referring to FIGS. 18 and 19, the window shade may be installed on a window frame of a room with the panel 618 of the panel assembly 604 facing the interior of the room. Like previously described, the two panels 616 and 618 can move relative to each other in opposite directions to pivot the transversal parts 620 between different angular positions, and the flaps 622 are movable along with the transversal parts 620. FIG. 18 illustrates the panel assembly 604 is in an open state where the transversal parts 620 are spaced apart from one another by multiple gaps 648 for light passage. FIG. 19 illustrates the panel assembly 604 in a closed state where the transversal parts 620 are positioned generally vertically and adjacently overlap with one another for blocking or reducing light passage. As shown in FIG. 19, when the panel assembly 604 is in the closed state, the flap 622 of each transversal part 620 can overlap a connection region 650 where one adjacent lower transversal part 620 is attached to the panel 616. This may prevent undesirable light leakage at the connection between each transversal part 620 and the panel 616. The flaps 622 can be respectively displaced away from the connection regions 650 when the panel assembly 604 is switched from the closed state to the open state.

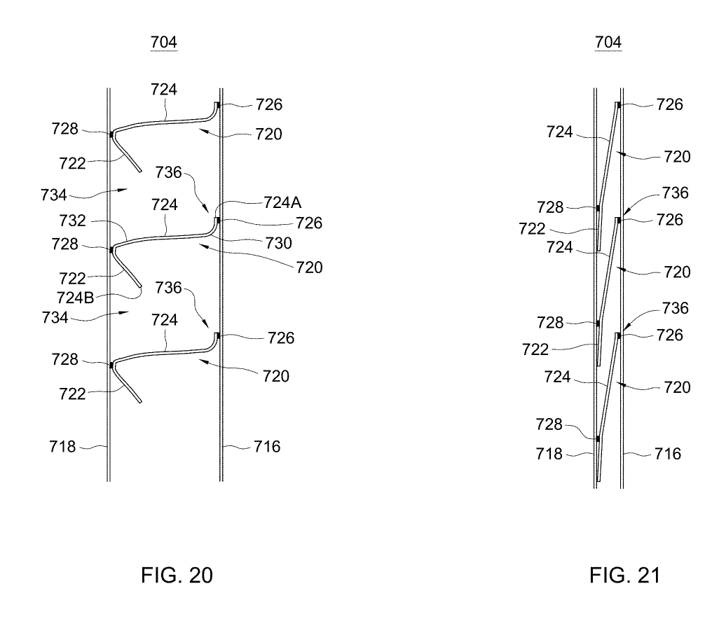

FIGS. 20 and 21 are two enlarged side views illustrating another embodiment of a panel assembly 704 for a window shade. Referring to FIGS. 20 and 21, the panel assembly 704 can include two panels 716 and 718, a plurality of parallel transversal parts 720, and a plurality of flaps 722 respectively coupled to the transversal parts 720. The transversal parts 720 are disposed between the two panels 716 and 718, each of the transversal parts 720 being respectively attached to the two panels 716 and 718. The two panels 716 and 718 may be made of flexible materials including, but not limited to, fabric materials, web materials, mesh materials, and the like. Examples of suitable materials for the transversal parts 720 may include, without limitation, fabric materials, web materials, mesh materials, plastic films, and the like. In some implementations, the two panels 716 and 718 may be exemplary transparent or translucent, and the transversal parts 720 may be opaque or have a light transmissivity smaller than the light transmissivity of the two panels 716 and 718.

In the embodiment of FIGS. 20 and 21, each of the transversal parts 720 can extend along the width direction of the panels 716 and 718 (i.e., perpendicular to the plane of FIGS. 20 and 21), and can respectively include a strip 724 having two opposite ends 724A and 724B. Examples of suitable materials for the strip 724 may include, without limitation, fabric materials, web materials, mesh materials, plastic films, and the like. The strip 724 of each transversal part 720 can be respectively attached to the two panels 716 and 718 with two adhesive layers 726 and 728. For example, the adhesive layer 726 can be applied to attach the panel 716 to the end 724A of the strip 724, and the adhesive layer 728 can be applied to attach the panel 718 to the strip 724 at a location between the two opposite ends 724A and 724B. More specifically, the adhesive layer 726 may attach the panel 716 to a surface 730 of the strip 724 at its end 724A, and the adhesive layer 728 may attach the panel 718 to another surface 732 of the strip 724 opposite to the surface 730. Each of the transversal parts 720 thereby formed has no cell.

The flap 722 of each transversal part 720 can be formed integrally with the strip 724. More specifically, the flap 722 of each transversal part 720 can be formed by a tail portion of the strip 724 that extends beyond the location where the adhesive layer 728 attaches the strip 724 to the panel 718 and terminates at the end 724B of the strip 724. The flap 722 thereby formed can protrude at a lower side of the transversal part 720 coupled thereto. Moreover, each flap 722 may extend continuously or discontinuously along the transversal part 720 coupled thereto.

Referring to FIGS. 20 and 21, the window shade may be installed on a window frame of a room with the panel 718 of the panel assembly 704 facing the interior of the room. Like previously described, the two panels 716 and 718 can move relative to each other in opposite directions to pivot the transversal parts 720 between different angular positions, and the flaps 722 are movable along with the transversal parts 720. FIG. 20 illustrates the panel assembly 704 in the open state where the transversal parts 720 are spaced apart from one another by multiple gaps 734 for light passage. FIG. 21 illustrates the panel assembly 704 in the closed state where the transversal parts 720 are positioned generally vertically and adjacently overlap with one another for blocking or reducing light passage. As shown in FIG. 21, when the panel assembly 704 is in the closed state, the flap 722 of each transversal part 720 can overlap a connection region 736 where one adjacent lower transversal part 720 is attached to the panel 716. This may prevent undesirable light leakage at the connection between each transversal part 720 and the panel 716. The flaps 722 can be respectively displaced away from the connection regions 736 when the panel assembly 704 is switched from the closed state to the open state.

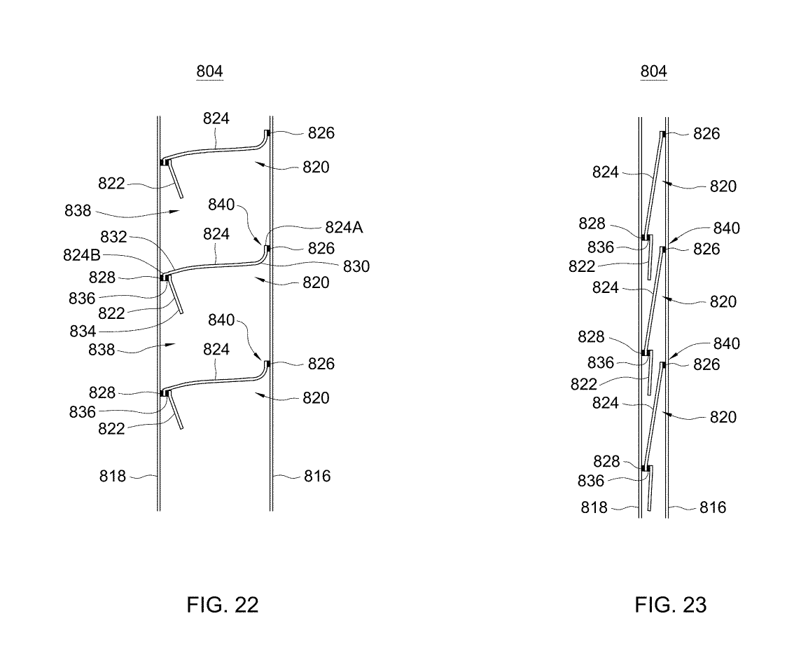

FIGS. 22 and 23 are two enlarged side views illustrating another embodiment of a panel assembly 804 for a window shade. Referring to FIGS. 22 and 23, the panel assembly 804 can include two panels 816 and 818, a plurality of parallel transversal parts 820, and a plurality of flaps 822 respectively coupled to the transversal parts 820. The transversal parts 820 are disposed between the two panels 816 and 818, each of the transversal parts 820 being respectively attached to the two panels 816 and 818. The two panels 816 and 818 may be made of flexible materials including, but not limited to, fabric materials, web materials, mesh materials, and the like. Examples of suitable materials for the transversal parts 820 may include, without limitation, fabric materials, web materials, mesh materials, plastic films, and the like. In some implementations, the two panels 816 and 818 may be exemplary transparent or translucent, and the transversal parts 820 may be opaque or have a light transmissivity smaller than the light transmissivity of the two panels 816 and 818.

In the embodiment of FIGS. 22 and 23, each of the transversal parts 820 can extend along the width direction of the panels 816 and 818 (i.e., perpendicular to the plane of FIGS. 22 and 23), and can respectively include a strip 824 having two opposite ends 824A and 824B. Examples of suitable materials for the strip 824 may include, without limitation, fabric materials, web materials, mesh materials, plastic films, and the like. The strip 824 of each transversal part 820 can be respectively attached to the two panels 816 and 818 with two adhesive layers 826 and 828. For example, the adhesive layer 826 can be applied to attach the panel 816 to the end 824A of the strip 824, and the adhesive layer 828 can be applied to attach the panel 818 to the end 824B of the strip 824. More specifically, the adhesive layer 826 may attach the panel 816 to a surface 830 of the strip 824 at its end 824A, and the adhesive layer 828 may attach the panel 818 to another surface 832 of the strip 824 at the end 824B that is opposite to the surface 830. Each of the transversal parts 820 thereby formed has no cell.

Each flap 822 may protrude at a lower side of the transversal part 820 coupled thereto, and may be formed by a strip 834 that has an end attached to the strip 824 of the transversal part 820 with an adhesive layer 836. Examples of suitable materials for the strip 834 may include, without limitation, fabric materials, web materials, plastic films, and the like. The flaps 822 and the transversal parts 820 may be made of a same material or include different materials. The strip 834 may be exemplary attached to the transversal part 820 adjacent to the location where the transversal part 820 attaches to the panel 818 so that the flap 822 is adjacent to the connection between the transversal part 820 and the panel 818. Each flap 822 may extend continuously or discontinuously along the transversal part 820 coupled thereto.

Referring to FIGS. 22 and 23, the window shade may be installed on a window frame of a room with the panel 818 of the panel assembly 804 facing the interior of the room. Like previously described, the two panels 816 and 818 can move relative to each other in opposite directions to pivot the transversal parts 820 between different angular positions, and the flaps 822 are movable along with the transversal parts 820. FIG. 22 illustrates the panel assembly 804 in the open state where the transversal parts 820 are spaced apart from one another by multiple gaps 838 for light passage. FIG. 23 illustrates the panel assembly 804 in the closed state where the transversal parts 820 are positioned generally vertically and adjacently overlap with one another for blocking or reducing light passage. As shown in FIG. 23, when the panel assembly 804 is in the closed state, the flap 822 of each transversal part 820 can overlap a connection region 840 where one adjacent lower transversal part 820 is attached to the panel 816. This may prevent undesirable light leakage at the connection between each transversal part 820 and the panel 816. The flaps 822 can be respectively displaced away from the connection regions 840 when the panel assembly 804 is switched from the closed state to the open state.

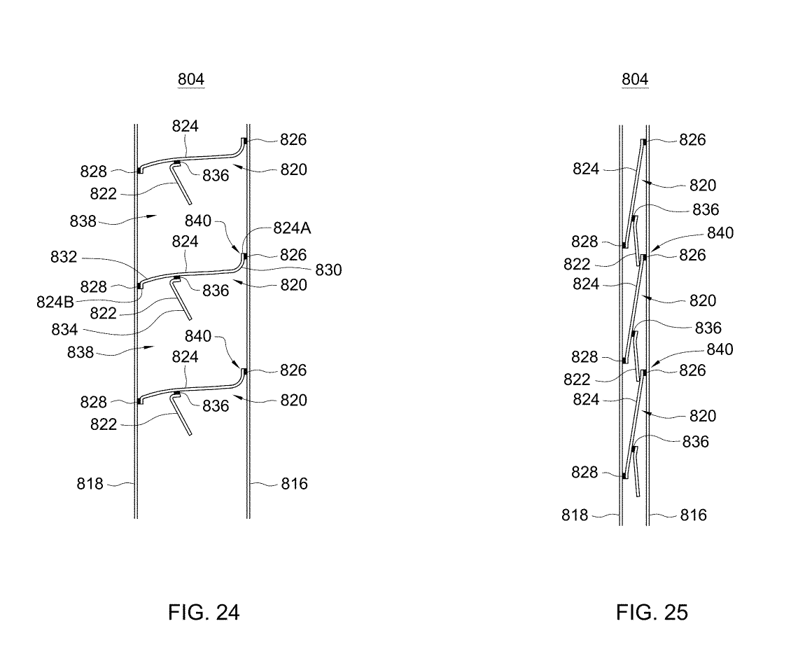

The aforementioned description includes an arrangement in which each flap may be disposed adjacent to the connection between the transversal part coupled thereto and one of the two panels. It will be appreciated, however, that the flaps described herein may be placed at other positions on their respective transversal parts. For example, FIGS. 24 and 25 are two enlarged side views illustrating a variant construction of the panel assembly 804 in which each flap 822 may protrude at a lower side of the transversal part 820 and may be attached to the strip 824 of the transversal part 820 at a location between the two ends 824A and 824B that is close to a middle of the strip 824.

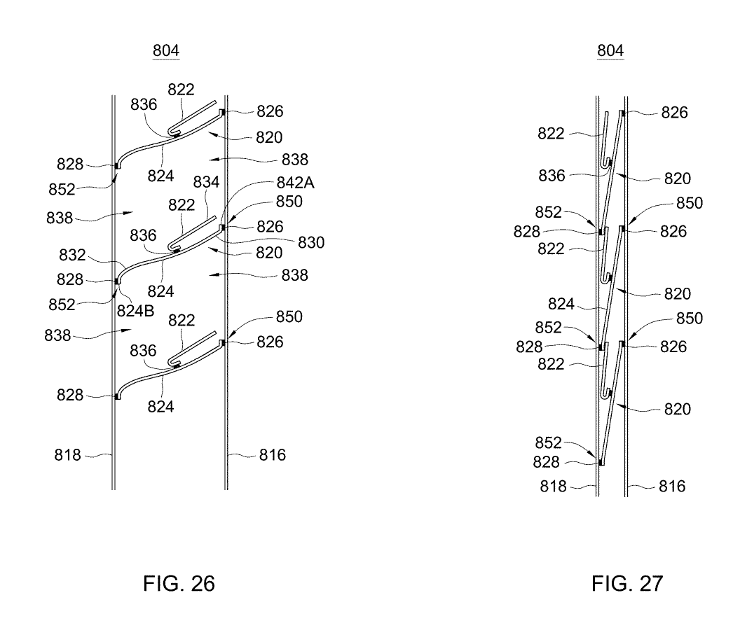

FIGS. 26 and 27 are two enlarged side views illustrating another variant construction of the panel assembly 804 in which each flap 822 may protrude at an upper side of the transversal part 820 and may be attached to the strip 824 of the transversal part 820 at a location between the two ends 824A and 824B that is close to a middle of the strip 824. As shown in FIG. 27, the flap 822 of each transversal part 820 can overlap a connection region 850 where the transversal part 820 is attached to the panel 816 in the closed state of the panel assembly 804. In the closed state, the flap 822 of each transversal part 820 may also overlap a connection region 852 where an adjacent upper transversal part 820 is attached to the panel 818. This can prevent undesirable light leakage at the connections between each transversal part 820 and the panels 816 and 818.

The embodiments described herein use adhesive layers for connecting various portions of the panel assemblies. It will be appreciated, however, that other techniques may be suitable. For example, welding, sewing, and the like may be applied to achieve structure connections in the panel assemblies.

Advantages of the structures described herein include the ability to provide improved thermal insulation and to better block or reduce light passage with a panel assembly that includes transversal parts having a cellular structure and/or flaps.

Realizations of the structures have been described only in the context of particular embodiments. These embodiments are meant to be illustrative and not limiting. Many variations, modifications, additions, and improvements are possible. These and other variations, modifications, additions, and improvements may fall within the scope of the claims that follow.

What is claimed is:

1. A panel assembly for a window shade, comprising:
a first and a second panel; and
a plurality of transversal parts disposed between the first and second panels, each of the transversal parts being respectively attached to the first and second panels and including at least one cell having a hollow cell interior;
wherein the first and second panels are movable relative to each other in opposite directions to pivot the transversal parts.

2. The panel assembly according to claim 1, wherein each of the transversal parts respectively includes a strip that is attached to the first and second panels and is folded over to delimit at least partially the hollow cell interior.

3. The panel assembly according to claim 2, wherein the strip has a first and a second surface opposite to each other, the first surface of the strip being attached to the first panel, and the second surface of the strip being attached to the second panel.

4. The panel assembly according to claim 2, wherein the strip has a same surface respectively attached to the first and second panels at two distant locations.

5. The panel assembly according to claim 2, wherein the strip has a first end attached to the first panel and a second end attached to a region of the strip located between the first and second ends.

6. The panel assembly according to claim 1, wherein each of the transversal parts respectively includes a first and a second strip that are attached to each other to delimit at least partially the hollow cell interior.

7. The panel assembly according to claim 6, wherein the first and second strips have different light transmissivity.

8. The panel assembly according to claim 1, wherein each of the transversal parts includes a plurality of cells.

9. The panel assembly according to claim 1, wherein each of the transversal parts is respectively coupled to a flap protruding at a lower side or an upper side thereof.

10. The panel assembly according to claim 9, wherein each of the transversal parts includes a first strip that is respectively attached to the first and second panels and is folded over to delimit at least partially the hollow cell interior, the flap being formed by a second strip having an end attached to the first strip.

11. The panel assembly according to claim 9, wherein each of the transversal parts includes a strip that is respectively attached to the first and second panels and is folded over to delimit at least partially the hollow cell interior, the flap being formed by a tail portion of the strip extending beyond the location where the strip is attached to the second panel.

12. The panel assembly according to claim 9, wherein each of the transversal parts includes a first and a second strip attached to each other that delimit at least partially the hollow cell interior, the first strip further being respectively attached to the first and second panels, the flap being formed by a tail portion of the first strip extending beyond the location where the first strip is attached to the second panel.

13. A panel assembly for a window shade, comprising:
a first and a second panel;
a first and a second transversal part disposed between the first and second panels, each of the first and second transversal parts being respectively attached to the first and second panels, the first and second panels being movable relative to each other in opposite directions to pivot the first and second transversal parts for switching the panel assembly between an open state and a closed state; and
a first and a second flap respectively coupled to the first and second transversal parts, the first flap of the first transversal part overlapping a connection region where the second transversal part is attached to the first panel in the closed state.

14. The panel assembly according to claim 13, wherein the first flap protrudes at a lower side or an upper side of the first transversal part.

15. The panel assembly according to claim 13, wherein the first flap is adjacent to a connection between the first transversal part and the second panel.

16. The panel assembly according to claim 13, wherein the first transversal part includes a strip respectively attached to the first and second panels, and the first flap is formed by a tail portion of the strip extending beyond the location where the strip is attached to the second panel.

17. The panel assembly according to claim 13, wherein the first transversal part includes a first strip respectively attached to the first and second panels, and the first flap is formed by a second strip having an end attached to the first strip.

18. The panel assembly according to claim 13, wherein the first transversal part includes a cell having a hollow cell interior, and the first flap extends outside the hollow cell interior.

19. The panel assembly according to claim 18, wherein the first transversal part includes a strip that is respectively attached to the first and second panels and is folded over to delimit at least partially the hollow cell interior, the first flap being formed by a tail portion of the strip extending beyond the location where the strip is attached to the second panel.

20. The panel assembly according to claim 18, wherein the first transversal part includes a first strip that is respectively attached to the first and second panels and is folded over to delimit at least partially the hollow cell interior, the first flap being formed by a second strip having an end attached to the first strip.

21. The panel assembly according to claim 18, wherein the first transversal part includes a first and a second strip attached to each other that delimit at least partially the hollow cell interior, the first strip further being respectively attached to the first and second panels, the first flap being formed by a tail portion of the first strip extending beyond the location where the first strip is attached to the second panel.

22. A window shade comprising:
a head frame; and
a panel assembly according to claim 1, wherein the panel assembly is retractable toward an interior of the head frame and expandable below the head frame.

23. A window shade comprising:
a head frame; and
a panel assembly according to claim 13, wherein the panel assembly is retractable toward an interior of the head frame and expandable below the head frame.
